(19) United States
(12) Patent Application Publication
(10) Pub. No.: US 2014/0052783 A1
(43) Pub. Date: Feb. 20, 2014

(54) WIRELESS BRIDGE FOR FACILITATING COMMUNICATION BETWEEN DIFFERENT NETWORK

(71) Applicant: LUTRON ELECTRONICS CO., INC., Coopersburg, PA (US)

(72) Inventors: Matthew J. Swatsky, Allentown, PA (US); John David Kruse, Emmaus, PA (US); Timothy Mann, Quakertown, PA (US); Jamie Steffie, I, Slatington, PA (US)

(21) Appl. No.: 13/835,001

(22) Filed: Mar. 15, 2013

Related U.S. Application Data
(60) Provisional application No. 61/683,153, filed on Aug. 14, 2012.

(51) Int. Cl. H04W 80/04; H04L 12/58

(52) U.S. Cl. CPC H04W 80/04; H04L 51/00
USPC 709/204; 709/232

(57) ABSTRACT

One or more load control devices and/or user interfaces that are part of a first network operating via a first protocol may communicate and/or control one or more load control devices and/or user interfaces that are part of a second network operating via a second protocol. For example, a wireless bridge may be provided. The wireless bridge may include a gateway. The gateway may be used to bridge the two networks that communicate using the different protocols such that the devices of the different networks may communicate with each other.

### CROSS-REFERENCE TO RELATED APPLICATIONS

This application claims the benefit of U.S. Provisional Patent Application No. 61/683,153, filed on Aug. 14, 2012, the disclosure of which is incorporated herein by reference in its entirety.

### BACKGROUND

Home automation systems, which have become increasing popular, may be used by homeowners to integrate and control multiple electrical and/or electronic devices in their house. For example, a homeowner may connect appliances, lights, blinds, thermostats, cable or satellite boxes, security systems, telecommunication systems, and the like to each other via a wireless network. The homeowner may control these devices using a controller or user interface provided via a phone, a tablet, a computer, and the like directly connected to the network or remotely connected via the Internet. These devices may communicate with each other and the controller to, for example, improve their efficiency, their convenience, and/or their usability.

Currently, many different networks and protocols may be used in a house to automate the electrical and/or electronic devices. For example, a homeowner may automate their cable or satellite box with their telephones or security system using products from their cable or satellite provider. To connect and/or control the cable or satellite boxes, telephones, and/or security system, the cable or satellite provider may use a particular network and protocol such as a Zigbee or Z-Wave network and protocol. The homeowner may also automate their lights and/or appliances using products such as dimmers, switches, and/or load control devices from a different provider. This provider may use a different network and protocol to connect and/or control the lights and/or appliances.

Unfortunately, a controller or user interface that may control, for example, the cable or satellite box, telephone, or security system connected on the Zigbee or Z-Wave network using the Zigbee or Z-Wave protocol may not be able to communicate with, configure, and/or control the lights and/or appliances connected to a different network that uses a different protocol, and vice-versa. As such, controllers or user interfaces may be incompatible with a different network in a house and may not be able to recognize and/or accommodate the devices associated with that network.

### SUMMARY

One or more load control devices and/or user interfaces that are part of a first network operating via a first protocol may communicate with and/or control one or more load control devices and/or user interfaces that are part of a second network operating via a second protocol. For example, a wireless bridge may be provided. The wireless bridge may include a gateway. The gateway may be used to bridge two networks having differing protocols together such that a controller or node of the first network that communicates using the first protocol may control a device or node on the second network that communicates using the second protocol.

To enable communication between networks of different protocols, the gateway may dynamically configure variable endpoints to map devices of the different networks. Such a configuration may enable or allow a user to integrate and/or provide communication between wireless devices or nodes like dimmers, thermostats, and shades to systems offered by telecommunications companies, cable companies, and security providers, or to devices or nodes of other parties, like door locks and smart meters. Such a configuration may also enable a controller to control devices on all of the networks.

Additionally, the gateway (e.g., included in the bridge) may be configured to register and/or maintain a mapping of such a registration between the different networks. For example, the gateway and/or device may associate a device on the second protocol-based network with an endpoint that may be used to communicate with the first protocol-based network in a mapping. Using the mapping, the gateway may be configured, at least in part, to identify messages sent between devices on the different networks and/or determine the correspondence or mapping between the devices on the different networks. The gateway may also translate and/or manage the messages between the different networks such that a message received, for example, from a first protocol-based network in a first protocol may be translated into a message of a second protocol capable of being interpreted by devices in a second protocol-based network.

### BRIEF DESCRIPTION OF THE DRAWINGS

FIG. 1 is a simple diagram of one or more devices of a first protocol-based network in communication with one or more devices of a second protocol-based network via an example bridge.

FIG. 2 is a simplified diagram of an example gateway that may be included in an example bridge.

FIGS. 3A-3B depict an example endpoint management table that may be maintained to store a mapping between devices of a protocol-based network and/or endpoints of a different protocol-based network.

FIG. 4 is an electrical block diagram of an example gateway that may be included in an example bridge.

FIG. 5 is a flowchart of an example method or procedure for associating a device from a protocol-based network with a controller of a different protocol-based network.

FIG. 6 is a flowchart of an example method or procedure for adjusting a device in a protocol-based network using a controller of a different protocol-based network.

FIG. 7 is a flowchart of an example method or procedure for adjusting a controller in a protocol-based network in response to an adjustment of a device of a different protocol-based network.

FIG. 8 is a flowchart of an example method or procedure for disassociating a device from a protocol-based network from a controller of a different protocol-based network.

### DETAILED DESCRIPTION

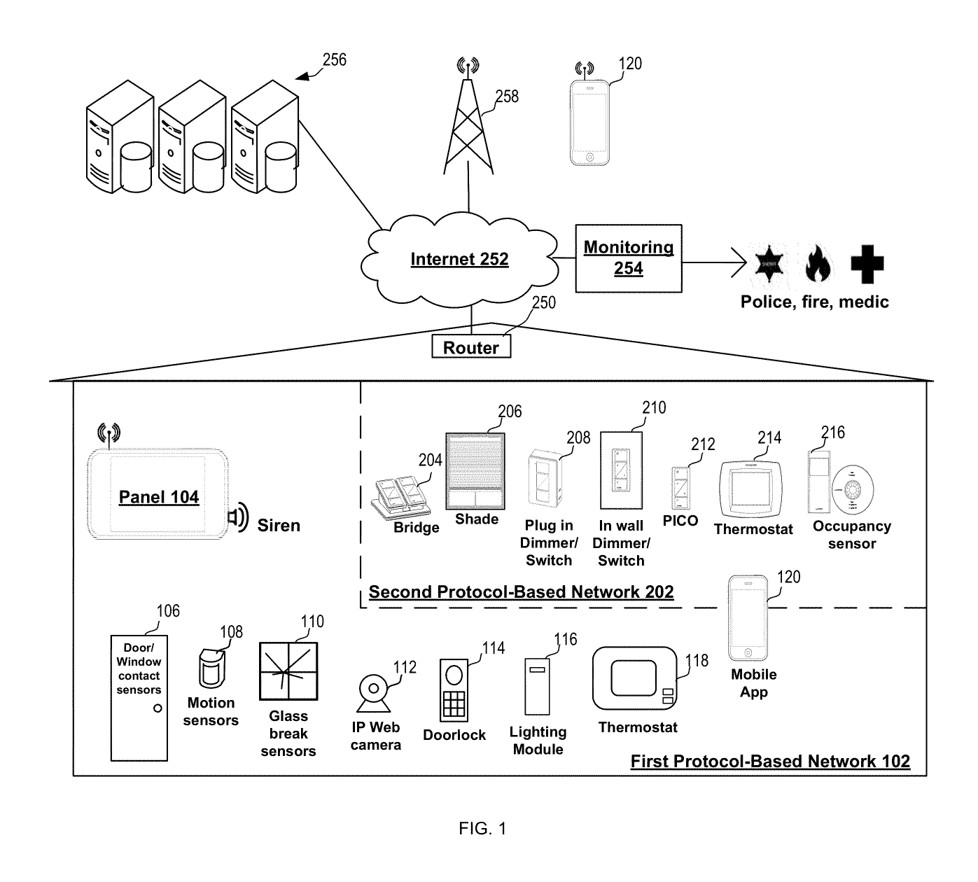

FIG. 1 is a simple diagram of one or more devices of a first protocol-based network 102 in communication with one or more devices of a second protocol-based network 202 via an example bridge 204. In FIG. 1, a user may interact with a panel 104, which may communicate wirelessly via a first protocol such as Zigbee, Z-wave, WiFi, GSM (Global System for Mobile Communication), and/or any other protocol, for example, to control one or more load control or monitoring devices of the first protocol-based network 102. For example, the panel 104 may communicate via the first protocol to control and/or interact with one or more devices such as, for example, a door and/or window contact sensor 106, a motions sensor 108, a glass break sensor 110, an IP (Internet Protocol) web camera 112, a door lock 114, a lighting module, a thermostats, and/or a mobile device 120.

The user may also interact with the panel 104 to control one or more load control or monitoring devices of the second protocol-based network 202 using a second protocol such as Clear Connect, WiFi, Z-wave, Zigbee, GSM, and/or any other protocol that may be different than the first protocol of the first protocol-based network 102. For example, the user may interact with the panel 104 associated with the first protocol-based network 102 to control and/or communicate with a shade 206, a plug-in dimmer and/or switch 208, an in-wall dimmer and/or switch 210, a pico controller 212, a thermostat 214, an occupancy sensor 216, and/or the mobile device 120 that may be part of the second protocol-based network 202 and may communicate using the second protocol.

To control the devices of the second protocol-based network 202, the panel 104 may communicate with a bridge 204 that may be a master keypad or keypad bridge. The bridge 204 may be configured to manage and/or translate a message of the first protocol received from the panel 104 into a message of the second protocol that may be recognized and/or interpreted by the devices of the second protocol-based network 202 such that the devices in the second protocol-based network 202 may be controlled from the panel 104. The bridge 204 may also be configured to manage and/or translate a message of the second protocol received from the devices of the second protocol-based network 202 into a message of the first protocol that may be recognized and/or interpreted by the panel 104 such that the panel 104 may be adjusted to reflect changes to the devices of the second protocol-based network 202.

For example, the bridge 204 may identify a first message received from a first node or device such as the panel 104 of the first protocol-based network 102 that may be sent via the first protocol. The bridge 204 may then determine a correspondence or an association between the first message and a second node or device such as, for example, the shade 206, the plug-in dimmer and/or switch 208, the in-wall dimmer and/or switch 210, the pico controller 212, the thermostat 214, and/or the occupancy sensor 216 of the second protocol-based network 202. The bridge 204 may also generate a second message via the second protocol that may correspond to the first message and may direct the second message to the second node or device such that the second node or device may be changed or adjusted in response to the first message from the first node or device.

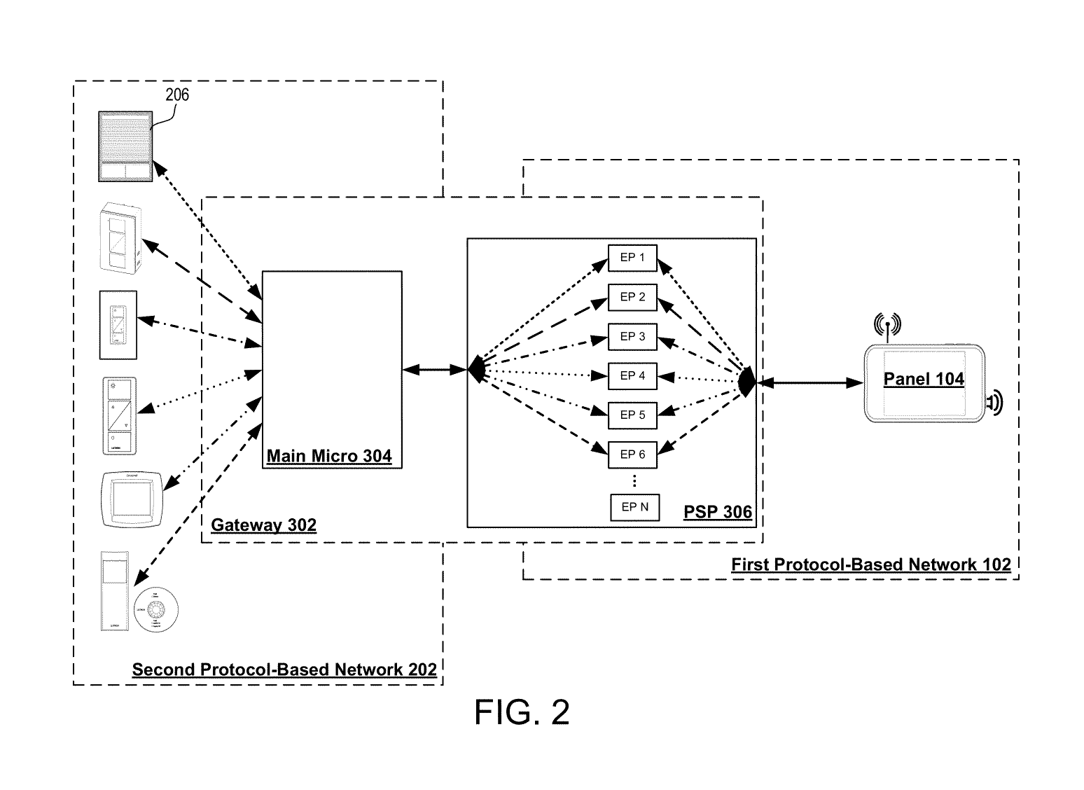

The bridge 204 may include a gateway (e.g., gateway 302 shown in FIG. 2) that may be physically situated therein. The gateway may perform dynamic configuration management of variable endpoints between the first and second-protocol-based networks 102, 202. For example, one or more of the devices on the second protocol-based network 202 may have respective variable endpoints dynamically mapped to the first protocol-based network 102 via the gateway in the bridge 204. Additionally, as devices are dynamically added (e.g., created) or removed from the second protocol-based network 202, the respective first protocol endpoint mappings may be added or removed from the gateway in the bridge 204. As such, the gateway may permit variable first protocol endpoint mapping to one or more devices of the second protocol-based network 202.

As shown, the panel 104 may also be connected to a router 250 via, for example, WiFi such that the panel 104 may have access to the Internet 252. Using the WiFi and internet connection, the panel 104 may communicate with and access server farms 256 associated with a provider of a data pipeline such that services including, for example, remote management, alerts/notifications, time clock scheduling, and/or video monitoring, and the like may be accessed. Additionally, municipal fire, police, and/or ambulance (e.g., 911 exchanges) may communicate with panel 104 via WiFi and/or the Internet 252 for emergency condition monitoring 254. The panel 104 may also communicate via WiFi or the Internet 252 with the various mobile devices such as the mobile device 120 via a cellular base station 258 when the user is outside of his or her house to, for example, indicate alert conditions, or to allow the user to control or monitor one or more of the devices on the first and second protocol-based networks 102, 202.

FIG. 2 is a simplified diagram of an example gateway 302 that may be included in an example bridge. The gateway 302 may dynamically identify a first node or device such as, for example, the shade 206, the plug-in dimmer and/or switch 208, the in-wall dimmer and/or switch 210, the pico controller 212, the thermostat 214, and/or the occupancy sensor 216 of the second protocol-based network 202. The gateway 302 may then dynamically identify a second protocol-based address of the first node or device and/or may dynamically determine or create a first protocol-based address for the first node or device corresponding to the second protocol-based address of the first node. The first protocol-based address for the first node or device may be used for the first node or device to communicate with the first protocol-based network 102. The gateway 302 may further dynamically register the first protocol-based address and the second protocol-based address such that the first protocol-based address corresponds to the second protocol-based address in the registration.

The gateway 302 may also communicate with a second protocol and the second protocol-based network 202 such as a 09-party network and a first protocol and the first protocol-based network 102 such as the Zigbee protocol-based network (e.g., including one or more of the Zigbee Alliance or Z-Wave radio frequency based protocols). For example, the gateway 302 may communicate with the first protocol-based network 102 via one or more controllers such as the panel 104 and also one or more of the devices such as the shade 206, the plug-in dimmer and/or switch 208, the in-wall dimmer and/or switch 210, the pico controller 212, the thermostat 214, and/or the occupancy sensor 216 of the second protocol-based network 202.

The gateway 302 may be physically located in the same enclosure as that of the bridge 204. Alternatively or additionally, the gateway 302 may be implemented in other nodes of the first or second protocol-based networks 102, 202 or another network, the gateway 302 may be distributed among one or more nodes of the first or second protocol-based networks 102,202 or another network, the gateway 302 may be physically situated in a unique node by itself on the first or second protocol-based networks 102, 202 or another network, and/or the gateway 302 may be implemented in a device gateway cluster.

As shown, the gateway 302 may include a main micro 304 (or an X-Ray or other suitable processor or controller) and a protocol stack provider (PSP) 306. The main micro 304 may include a processor and/or controller. The processor and/or controller may provide and/or facilitate communication using the second protocol between the bridge 204 and the devices such as the shade 206, the plug-in dimmer and/or switch 208, the in-wall dimmer and/or switch 210, the pico controller 212, the thermostat 214, and/or the occupancy sensor 216 of the second protocol-based network 202 such that the bridge 204 and/or the main micro 304 may control the devices of the second protocol-based network 202.

The main micro 304 may also include one or more user interfaces and/or a table such as a filter table. As described herein, the user interfaces may be used to configure a device or node of the second protocol-based network 202 to be associated with and added to, for example, a device or node such as the panel 104 of the first protocol-based network 102. Additionally, the table such as the filter table may be used to store and/or manage device information such as serial numbers or other identifiers associated with the devices of the second protocol-based network 202.

The main micro 304 may be in communication with the PSP 306 via a connection interface such as a universal asynchronous receiver/transmitter (UART) interface. The PSP 306 may receive messages that may be received and/or decoded by the main micro 304 from the devices of the second protocol-based network 202 via the UART interface. The PSP 306 may then identify a node configured to communicate via the first protocol with the first protocol-based network 102 corresponding to the device in the second protocol-based network from which the message may have been received. The PSP 306 may broadcast information included in the message via the node to a device of the first protocol-based network 102.

For example, the PSP 306 may define one or more endpoints (e.g., EP1-EPN) that may be used to route messages between the first and second-protocol based networks 102, 202 and the devices thereof. To the first protocol-based network 102, each of the devices of the second protocol-based network 202 such as the shade 206, the plug-in dimmer and/or switch 208, the in-wall dimmer and/or switch 210, the pico controller 212, the thermostat 214, and/or the occupancy sensor 216 may appear as an equivalent first protocol-based device using one or more endpoints. As such, each of the endpoints, for example, EP1-EPN may represent a device on the second protocol-based network 202.

A mapping between the devices and endpoints may be maintained at the gateway 302 via the main micro 304 and PSP 306. The mapping may include, for example, a logical mapping between information associated with devices of the second-protocol based network 202 such as serial identifiers (IDs) and the endpoints EP1-EPN that may be included in the PSP 306. The mapping may be maintained and/or stored in an endpoint management table.

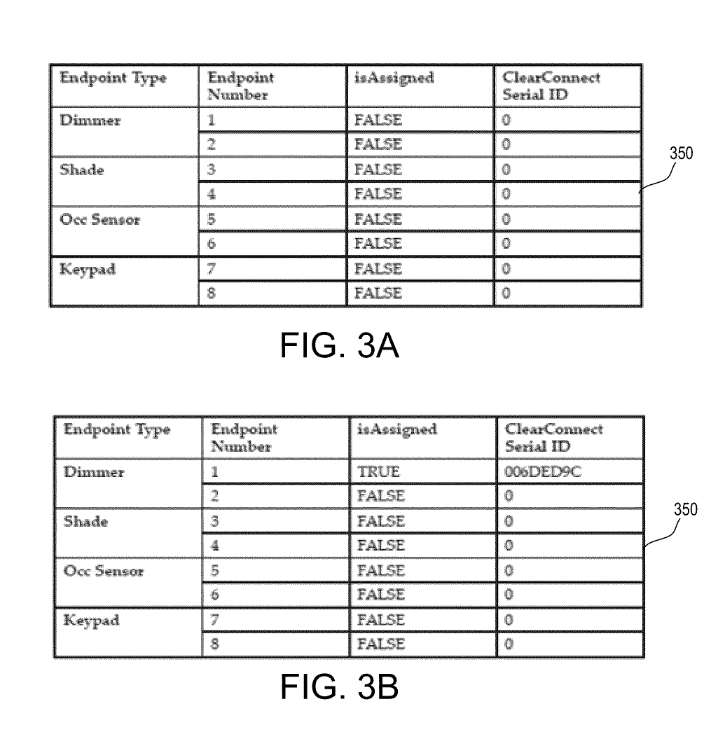

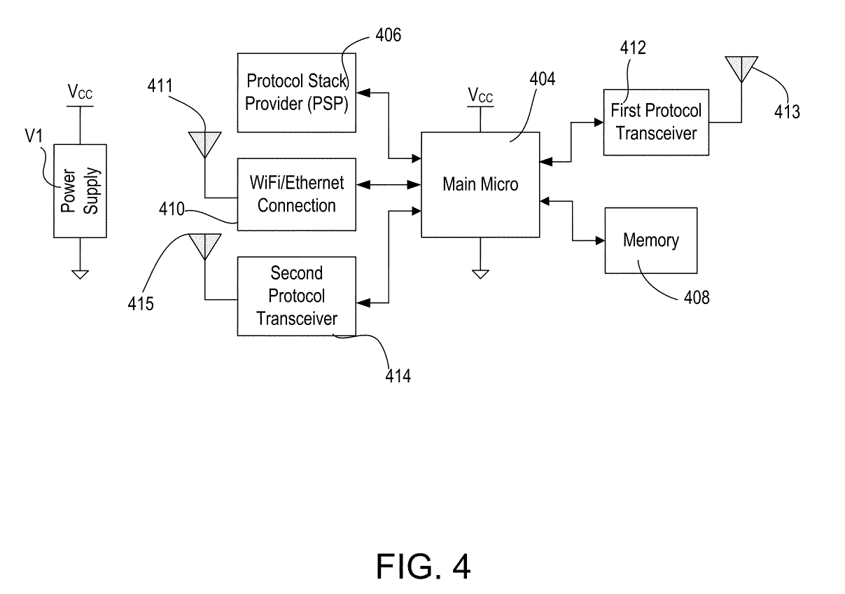

FIGS. 3A-3B depict an example endpoint management table 350 that may be maintained to store the mapping between devices and/or endpoints. As shown, the endpoint management table 350 may include and/or maintain the mapping between an endpoint (e.g., the endpoint number) or address of the first protocol-based network, device information such as a serial identifier (ID) of a device of, for example, the second protocol-based network 202, and/or an indication of whether the endpoint and/or serial identifier is actually mapped or assigned (e.g., True indicating a mapping or assignment and False indicating no mapping or assignment). The mapping included in the endpoint management table 350 may be dynamic to accommodate variable endpoints on the second protocol-based network 202 such that the endpoints may be added, removed, and/or changed dynamically. The mapping may also be used to route and/or translate messages from the first to second protocols, and vice-versa, and the devices associated with the first and second protocol-based networks 102, 202.

In addition to the mapping between the devices and the endpoints, the endpoint management table 350 may include the type of device being associated or mapped from the second-protocol-based network 202. For example, the gateway 302 or the main micro 304 thereof may be configured to identity a type of device such as a switch, button, dimmer, ballast, and the like being added or created. The gateway 302 may identify the type of device based on its serial number or other communication from the device when the device is being added, from a pre-configuration, and/or from any other suitable user input. The type of device may be associated with the device information or identifiers and/or endpoints in the endpoint management table 350. The gateway 302 may use the identified type to select an appropriate application profile such as an appropriate first protocol-based application profile for the endpoint, which may be reflected in the endpoint management table 350 or other components of the gateway 302.

FIG. 4 is an electrical block diagram of an example gateway that may be included in an example bridge. The example gateway may be, for example, the gateway 302 depicted in FIG. 2. As shown, the gateway may include a main micro 404. The main micro 404 may be a processor and/or controller configured to receive and/or process messages from a first and/or second protocol-based network. For example, the main micro 404 may provide and/or facilitate communication between a bridge and devices of the second protocol-based network using a second protocol such that the bridge and/or the main micro 404 may control the devices of the second protocol-based network. The main micro 404 may be configured to provide or display one or more user interfaces that may be used to set up a mapping between devices of different networks.

The gateway also comprises a memory 408 for storage of unique identifiers such as a serial number, a MAC address, and the like of devices of, for example, the second protocol-based network. For example, the main micro 404 may include a table such as a filter table that may be used to store and/or maintain the unique identifiers. The memory 408 may store such a table for the main micro 404. The memory 408 may further store the user interfaces that may be displayed and/or interacted with to configure an association or registration of a device.

As shown, the gateway also includes a PSP 406. The PSP 406 may define one or more endpoints that may be used to route messages between different (e.g. first and second) protocol-based) networks and the devices thereof. A mapping between the devices and endpoints may be maintained in an endpoint management table of the PSP 406.

The gateway may further include a power supply V1. The power supply V1 may provide a DC voltage Vcc (e.g., 120V) for powering the main micro 404, the memory 408, the PSP 406, and/or other circuitry of the gateway. The power V1 may include a battery, a connection to an electrical outlet, and the like.

Additionally, the gateway includes a WiFi and/or Ethernet connection 410, a first protocol transceiver 412, and a second protocol transceiver 414 that may be coupled to the main micro 404 and/or respective antennas 411, 413, and 415. The WiFi and/or Ethernet connection 410 may provide an interface for accessing gateway remotely via the Internet (e.g., the Internet 254 shown in FIG. 1) and/or for the gateway to access services provided via the Internet.

The transceivers 412 and/or 414 may be configured to receive a message or a command in a protocol recognized by the transceiver and to transmit the message to the main micro 404 and/or the PSP 406. The main micro 404 and/or PSP 406 may then identify the message and/or a device or endpoint associated therewith, may translate the message or command into an appropriate protocol for a recipient in a different network, and/or may cause the transceivers 412 or 414 to transmit the translated message or command in the appropriate protocol to a device in the network thereof. The transceivers 412 or 414 may also receive one or more commands in the different protocols to register a device to be mapped between the networks and/or unregister a device being mapped between the networks.

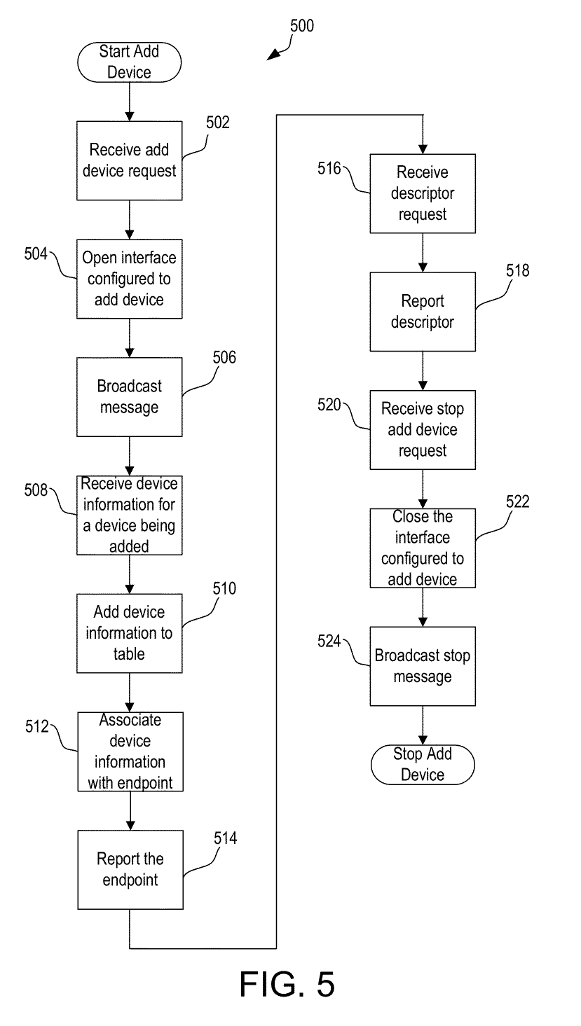

FIG. 5 is a flowchart of an example method or procedure 500 for associating a device or node from a protocol-based network with a device or node such as the panel 104 of a different protocol-based network. For example, a user may interact with the panel 104 to add a device from the second protocol based-network 202 such that the panel 104 may control and/or communicate with that device. To register or add the device, the panel 104 may send or broadcast an add device request or message to the gateway 302 and, in particular, to the PSP 306 at 502. The add device request or message may include a start-add-device [time] command. The start-add-device [time] command may inform the gateway 302 that it may allow and/or enable devices to be added and/or that a user wishes to add a device from a different protocol based network to the panel 104. This command may or may not use an argument or parameter. For example, a time argument or parameter such as an amount of time for which the gateway 302 may allow devices to join may be part of this command and may be provided in the request or message received by the gateway 302. Additionally, this command may be received in the first protocol of the first protocol-based network 102.

After receiving the add device request or message, an interface and/or window may be opened by the gateway 302 at 504. For example, the PSP 306 may forward the add device request or message to the main micro 304. The main micro 304 may then open an interface or window configured to be interacted with by the user to add the device from the second protocol-based network. The gateway 302 via the main micro 304 and PSP 306 may also interpret the add device request or message in the first protocol and may translate it into the second protocol that may be recognized by the devices of the second protocol-based network 202.

After opening the interface and/or interpreting or translating the add device request or message, the gateway 302 may broadcast a message corresponding to or associated with the add device request or message to the device of the second protocol-based network 202 at 506. For example, the main micro 304 may broadcast the message to one or more devices in the second protocol-based network 202. The message may be in the second protocol that may be recognizable to the devices of the second protocol-based network 202 and may indicate that the panel 104 would like to control and/or add a particular device thereto.

In response to the message or in response to an actuation of the device itself (i.e., without the request from the panel 104 to add a device), one or more of the devices of the second protocol-based network 202 may compile device information of themselves such as a serial number, MAC address, a device type, and the like. For example, the message or an actuation of a device itself may indicate a particular device from the second protocol-based network 202 the user wishes to add to the panel 104. The user may interact with that particular device to register the device with the first protocol-based network 102. For example, in response to receiving the message or in response to an actuation of the device, the interface or window may indicate that a user press a button of the particular device. The device may then compile its device information and may broadcast or send that device information back to the gateway 302 such that the gateway 302 and the main micro 304 thereof may receive the device information at 508.

The gateway 302 may add the device information to, for example, one or more tables included therein at 510 and may associate the device information with an endpoint at 512. For example, after receiving the device information at 508, the main micro 304 may add the device information to a table such as a filter table thereof. The main micro 304 may then report the device information to the PSP 306. The PSP 306 may associate the device information with an endpoint and may add the endpoint and the association to an endpoint management table. For example, the PSP 306 may associate the serial number and/or device type with a particular endpoint such as EP1 and may store that association and an indication of its assignment in the endpoint management table 350 shown in FIGS. 3A-3B.

At 514, the gateway 302 may report or send an indication of the endpoint added and associated with the device to the panel 104. The indication of the endpoint being added may be provided using a device-added [endpoint] command. This command may inform the panel 104 that the device has been added and that a new mapping for the device against the endpoint, for example, has been created. The device-added [endpoint] command may include an “endpoint” argument or parameter. The endpoint argument or parameter may indicate the endpoint against which the device has been mapped.

Following this indication or command, the panel 104 may request a description or descriptor such as a device type of the device represented by the endpoint. The panel 104 may sent such a descriptor request to the gateway 302 using, for example, a SIMPLE DESCRIPTOR request to the particular endpoint to determine the type of device associated therewith.

The gateway 302 may receive the request at 516 and may report the descriptor back to the panel at 518. For example, the PSP 306 may receive the descriptor request and may look up the descriptor associated with the device in the endpoint management table 350. The PSP 306 may then report or send the descriptor back to the panel 104 at 518.

The panel 104 may then add or store the device represented by the endpoint such that the panel 104 may display an interface with the device of the second protocol-based network 202 and the user may interact with the interface to control the device. The panel 104 may also generate and broadcast a stop add device request or message to the gateway 302 signaling that the device may have been added and/or to stop adding device. For example, the stop add device request or message may include a stop-add-device command that may inform the gateway 302 to stop adding third-party devices into the first protocol-based network 102.

The gateway 302 may receive the stop add device request or message at 520 and, in response to the message, the gateway 302 may close the interface configured to add a device at 522 and broadcast a stop message at 524. For example, the PSP 306 may receive the stop add device request or message at 520. The PSP 306 may forward the request onto to the main micro 304 such that the main micro 304 may close the interface or window that may be used to add a device at 522. The main micro 304 may also broadcast a stop message to the devices of the second protocol-based network 202 at 524. The stop message may be received by the devices and the devices of the second protocol-based network may now be configured to be controlled by the panel 104.

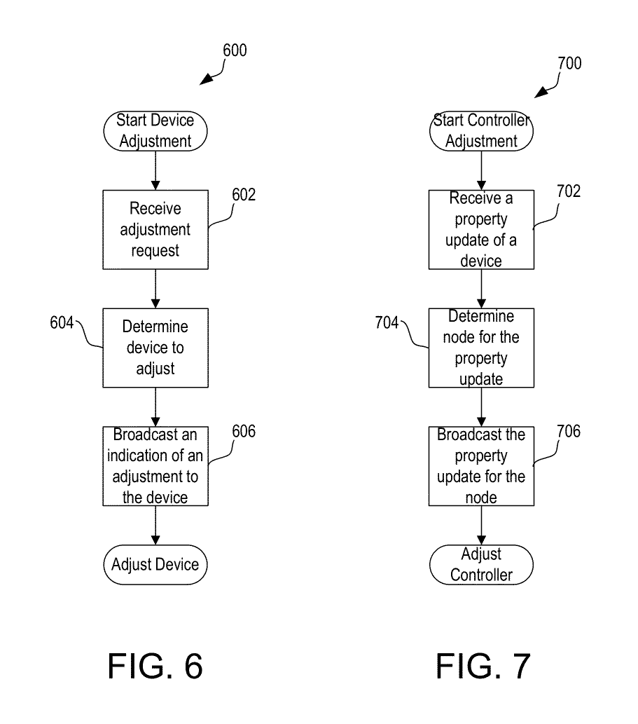

FIG. 6 is a flowchart of an example method or procedure 600 for adjusting a device in a protocol-based network using a controller of a different protocol-based network. For example, a user may interact with the panel 104 to adjust and/or control a device of the second protocol-based network 202. To adjust and/or control the device, the user may push a button on the panel 104 and/or may interact with a touch interface provided by the panel 104. In response to such an interaction, the panel 104 may send an adjustment request or message that may include an indication of a desired adjustment of the device to the gateway 302 and, in particular, to the PSP 306 at 602.

At 604, the gateway 302 may determine the particular device to adjust based on the request or message. For example, the PSP 306 may receive the request from the panel 104 at 602. The request may include the endpoint that the user wishes to adjust. The PSP 306 using the endpoint management table 350 may determine the device associated with the endpoint and may provide the device information such as the device serial number and an indication of the type of adjustment being made to the main micro 304. For example, the PSP 306 may compare an endpoint associated with the message received at 602 with endpoints in the endpoint management table 350 and, when matched, may determine or identify the device of the second protocol-based network 202 that adjustment should be made on (e.g., based on the device information associated with the matched endpoints). The device information may then be provided to the main micro 304.

The gateway 302 may then broadcast and indication of the adjustment to the device of the second protocol-based network 202 at 606. For example, in response to receiving the device information and the adjustment the user wishes to make to a device, the main micro 304 may translate the information and/or adjustment provided in the first protocol and may direct that such an adjustment be made to the desired device. In particular, the main micro 304 may generate an indication or message compatible with the second protocol and may broadcast that message to the device the user wishes to adjust. The indication or message may include information or a command of the actual adjustment the user wishes to make to the device. For example, the indication or message may include, for example, an intensity adjustment or a lighting adjustment command associated with an adjustment the user wishes to make to an electrical load of the particular device. The device and/or an electrical load it may control may then be adjusted in response to such a command.

FIG. 7 is a flowchart of an example method or procedure 700 for adjusting a controller in a protocol-based network in response to an adjustment of a device of a different protocol-based network. For example, a user may physically interact with an actual device of a second protocol-based network 202 to make an adjustment thereto. In particular, the user may actuate the device to change a dimming level of an electrical load. In response to such an actuation, the device may generate a property update message in the second protocol. The property update message may be broadcasted to and received by the gateway 302 and, in particular, by the main micro 304 at 702.

At 704, the gateway 302 may determine a node recognizable by the first protocol-based network 102 associated with the device. For example, the main micro 304 may forward the property update message to the PSP 306. The property update message may include the device information such as the device serial number and an indication of an indication of the type of adjustment made to the actual device. The PSP 306 may determine a node that corresponds to the device using the endpoint management table 350 at 704. For example, the PSP 306 may look up the endpoint associated with the device information provided in the property update message. To lookup the endpoint, the PSP 306 may compare an endpoint associated with the message received at 702 with endpoints in the endpoint management table 350 and, when matched, may determine or identify the device of the first protocol-based network to which to provide the adjustment.

The gateway may then broadcast an indication of the adjustment made the device of the first protocol-based network 102 and the panel 104 thereof at 706. For example, in response to receiving the property update message, the main micro 304 may translate the information and/or adjustment provided in the second protocol and may direct that such an adjustment be made to the panel 104 using the endpoint. In particular, the PSP 306 may generate an indication or message compatible with the second protocol and may broadcast that message to the panel 104. The indication or message may include information or a command of the actual adjustment made to the device. For example, the indication or message may include, for example, an intensity adjustment or a lighting adjustment made to the device. The panel 104 may then update itself to reflect the actual adjustment to the user on an interface thereof.

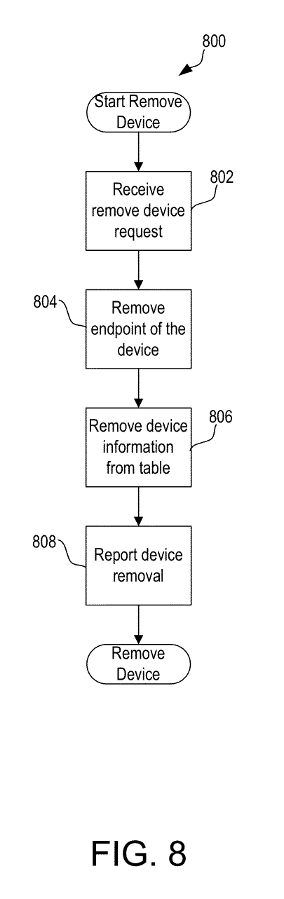

FIG. 8 is a flowchart of an example method or procedure 800 for disassociating a device from a protocol-based network from a controller of a different protocol-based network. For example, a user may interact with the panel 104 to remove a device of the second protocol-based network 202. To remove the device, the user may push a button on the panel 104 and/or may interact with a touch interface provided by the panel 104. In response to such an interaction, the panel 104 may send a remove device request or message that may include an indication of a desired device to be removed to the gateway 302 and, in particular, the PSP 306 at 802.

The remove device request or message may include a remove-device [endpoint] command. Such command may inform the gateway 302 that it may remove the device. The command may also include an argument or parameter “endpoint.” The endpoint argument or parameter may indicate which endpoint may be mapped to the device the user wishes to remove.

At 804, the gateway 302 may remove the endpoint associated with the device. For example, the PSP 306 may receive the request from the panel 104 at 802. The request may include the endpoint that the user wishes to remove. The PSP 306 using the endpoint management table 350 may remove the endpoint associated with the particular device. The PSP 306 may then provide an indication of the removal of the endpoint and the device information such as the serial number associated with the endpoint to the main micro 304.

At 806, the gateway 302 may remove the device information associated with the removed endpoint from a table. For example, the main micro 304 may subsequently remove the device information from the filter table included therein.

After removing the endpoint and device information, the gateway 302 may broadcast an indication of the removal of the device to the device itself at 808 and/or to the panel 104. For example, the main micro 304 may translate the information and/or removal provided in the first protocol and may inform such a removal to the desired device by broadcasting and indication to that device in the second protocol. In particular, the main micro 304 may generate an indication or message compatible with the second protocol and may broadcast that message to the device the user wishes to remove.

The gateway 302 may also broadcast an indication that the device removal has been complete back to the panel 104 at 808, for example. Such an indication may include a device removed [endpoint] command. This command may inform the panel 104 that the device has been removed and may be sent in response to a ‘remove-device’ command from the panel 104, and/or if the device becomes unavailable due to some reason. The command may also include an argument or parameter “endpoint.” The endpoint argument or parameter may indicate which endpoint was actually removed.

What is claimed is:

1. A device for performing communication translation between a first protocol-based network and a second protocol-based network, the device comprising:
a processor configured to:
identify a first message received from a first node of the first protocol-based network, the first message sent via the first protocol;
determine a correspondence between the first message and a second node of the second protocol-based network;
generate a second message via the second protocol, the second message corresponding to the first message; and
direct the second message to the second node.

2. The device of claim 1, wherein the first protocol comprises at least one of Zigbee or Z-wave.

3. The device of claim 1, wherein the second protocol comprises Clear Connect.

4. The device of claim 1, wherein the first message comprises at least one of the following: an indication of an adjustment to make to the second node or an indication on whether to add the second node from the second protocol-based network or remove the second node from the second protocol-based network.

5. The device of claim 4, wherein the first message further comprises at least one of a command or a request to the second node communicated in the first protocol.

6. The device of claim 5, wherein the second message comprises at least one of the command or the request to the second node translated into the second protocol.

7. The device of claim 1, wherein to determine the correspondence between the first message and the second node of the second protocol-based network, the processor is further configured to compare an endpoint provided in the first message with endpoints in an endpoint management table.

8. The device of claim 7, wherein the processor is further configured to direct the second message to the second node based on the comparison between the endpoints in the endpoint management table.

9. A device for performing communication registration between a first-protocol-based network and a second-protocol-based network, the device comprising:
a processor configured to:
dynamically identify a first node of the second-protocol-based network;
dynamically identify a second protocol-based address of the first node;
dynamically create a first protocol-based address for the first node corresponding to the second-protocol-based address of the first node; and
dynamically register the first protocol-based address and the second protocol-based address such that the first protocol-based address corresponds to the second protocol-based address in the registration.

10. The device of claim 9, wherein the processor is further configured to dynamically determine a node type for the first node, and wherein the dynamic registration further includes a mapping between the first protocol-based address of the first node, the second protocol-based address of the first node, and the node type for the first node.

11. The device of claim 9, wherein the first protocol-based address comprises at least one of a Zigbee endpoint or Z-wave endpoint.

12. The device of claim 9, wherein the second protocol-based address comprises a Clear Connect serial identifier.

13. The device of claim 9, wherein the dynamic registration is made using an endpoint management table.

14. The device of claim 13, wherein the endpoint registration management table comprises the first protocol-based address, the second protocol-based address, and an indication of whether the first protocol-based address and the second protocol-based address are mapped.

15. A device for initiating communication registration between a first protocol-based network and a second protocol-based network, the device operating as a first node of the first protocol-based network, the device comprising:
a processor configured to:
identify a first input as a command to register a second node of the second protocol-based network;
initiate a first message to a third node in response to the first input to register the second node, the third node being in communication with the first node and the second protocol-based network; and
receive a second message from the third node, the second message indicating a first protocol-based registration of the second node.

16. The device of claim 15, wherein the second message comprises an endpoint of the first protocol-based-registration of the second node.

17. The device of claim 15, wherein the first protocol comprises at least one of Zigbee or Z-wave.

18. The device of claim 15, wherein the second protocol comprises Clear Connect.

19. The device of claim 15, wherein the first input comprises at least one of an actuation of the second node or an interaction with the first node.

20. The device of claim 15, wherein the processor is further configured to associate the second node with an endpoint of the first node in an endpoint management table during the first protocol-based registration of the second node.
